(19) United States
(12) Patent Application Publication
(10) Pub. No.: US 2026/0292213 A1
(43) Pub. Date: Sep. 24, 2026

(54) METHOD FOR ADAPTIVE SEARCH REGION DETERMINATION FOR TEMPLATE MATCHING PREDICTION

(71) Applicants: Hyundai Motor Company, Seoul (KR); Kia Corporation, Seoul (KR); KWANGWOON UNIVERSITY INDUSTRY-ACADEMIC COLLABORATION FOUNDATION, Seoul (KR)

(72) Inventors: Dong Gyu SIM, Seoul (KR); Min Hun LEE, Uijeongbu-si, Gyeonggi-do (KR); Joo Hyung BYEON, Seoul (KR); Jung Ah CHOI, Seoul (KR); Jin HEO, Yongin-si, Gyeonggi-do (KR); Seung Wook PARK, Yongin-si, Gyeonggi-do (KR)

(73) Assignees: Hyundai Motor Company, Seoul (KR); Kia Corporation, Seoul (KR); KWANGWOON UNIVERSITY INDUSTRY-ACADEMIC COLLABORATION FOUNDATION, Seoul (KR)

(21) Appl. No.: 19/475,612

(22) PCT Filed: Mar. 5, 2024
(86) PCT No.: PCT/KR2024/002798

§ 371 Date: Oct. 15, 2025

(30) Foreign Application Priority Data
May 10, 2023 (KR) 10-2023-0060327
Mar. 4, 2024 (KR) 10-2024-0030641

(51) Int. Cl. H04N 19/176; H04N 19/124; H04N 19/137; H04N 19/159; H04N 19/46; H04N 19/593; H04N 19/60; H04N 19/70; H04N 19/91

(52) U.S. Cl. CPC H04N 19/176; H04N 19/124; H04N 19/137; H04N 19/159; H04N 19/46; H04N 19/593; H04N 19/60; H04N 19/70; H04N 19/91

(57) ABSTRACT

A method and an apparatus are disclosed for video coding determining search regions adaptively for template matching prediction. In the disclosed embodiments, the video decoding device determines search regions in a neighboring reconstructed region of the current block for use in template matching. The video decoding device obtains motion information of adjacent regions to the current block, and relocates the search regions and reorders the search order based on the motion information. The video decoding device searches for a template with a minimum cost based on a cost of the template matching by performing a region-by-region search in the search order, and determines a prediction block of the current block based on the template with the minimum cost.

### TECHNICAL FIELD

The present disclosure relates to a video coding method and an apparatus determining search regions adaptively for template matching prediction.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

In enhanced compression bodel (ECM), a next-generation technology, the intra template matching prediction (IntraTM) technology sets an L-shaped, left, and/or top template neighboring the current block, searches in the current frame's reconstructed region for the most similar template to the current template, and then takes the block adjacent to the searched template and with the same size as the current block for use as the prediction block of the current block. The IntraTMP technology searches for similar templates based on a loss function which is sum of absolute differences (SAD). Four search regions, as shown in FIG. 6, are used for template matching. The IntraTMP technique uses the search order R4→R1→R3→R2 with the search regions shown in FIG. 6, and uses a reverse z-scan order, searching from the bottom right to the top left of each search region. These search regions and search order are just exemplary. Therefore, to increase video coding efficiency and enhance video quality, there is a need for a method of effectively determining the search region and search order when applying the IntraTMP technique to the current block.

### DISCLOSURE

### Technical Problem

The present disclosure seeks to provide a video coding method and an apparatus that, when an intra template matching prediction (IntraTMP) technology is applied to the current block, adaptively determine search regions for template matching and a search order with respect to the search regions.

### Technical Solution

At least one aspect of the present disclosure provides a method of reconstructing a current block by a video decoding apparatus. The method includes determining lower-level search regions in a neighboring reconstructed region of the current block for use in template matching. Here, each of the lower-level search regions is included in one of upper-level search regions that comprise a top search region, a left search region, and a top-left search region, and each of the upper-level search regions includes at least two or more lower-level search regions. The method also includes obtaining motion information of adjacent regions to the current block. The method also includes relocating the lower-level search regions based on the motion information. The method also includes determining a search order with respect to the lower-level search regions based on distances from the current block. The method also includes searching for a template with a minimum cost based on a cost of the template matching by performing a region-by-region search in the search order. Here, the cost is dependent on a difference between a template of the current block and a template in each of the lower-level search regions. The method also includes determining a prediction block of the current block based on the template with the minimum cost.

Another aspect of the present disclosure provides a method of encoding a current block by a video encoding apparatus. The method includes determining lower-level search regions in a neighboring reconstructed region of the current block for use in template matching. Here, each of the lower-level search regions is included in one of upper-level search regions that comprise a top search region, a left search region, and a top-left search region, and each of the upper-level search regions includes at least two or more lower-level search regions. The method also includes obtaining motion information of adjacent regions to the current block. The method also includes relocating the lower-level search regions based on the motion information. The method also includes determining a search order with respect to the lower-level search regions based on distances from the current block. The method also includes searching for a template with a minimum cost based on a cost of the template matching by performing a region-by-region search in the search order. Here, the cost is dependent on a difference between a template of the current block and a template in each of the lower-level search regions. The method also includes determining a first prediction block of the current block based on the template with the minimum cost.

Yet another aspect of the present disclosure provides a computer-readable recording medium storing a bitstream generated by a video encoding method. The video encoding method includes determining lower-level search regions in a neighboring reconstructed region of a current block for use in template matching. Here, each of the lower-level search regions is included in one of upper-level search regions that comprise a top search region, a left search region, and a top-left search region, and each of the upper-level search regions includes at least two or more lower-level search regions. The video encoding method also includes obtaining motion information of adjacent regions to the current block. The video encoding method also includes relocating the lower-level search regions based on the motion information. The video encoding method also includes determining a search order with respect to the lower-level search regions based on distances from the current block. The video encoding method also includes searching for a template with a minimum cost based on a cost of the template matching by performing a region-by-region search in the search order. Here, the cost is dependent on a difference between a template of the current block and a template in each of the lower-level search regions. The video encoding method also includes determining a prediction block of the current block based on the template with the minimum cost.

### Advantageous Effects

As described above, the present disclosure provides a video coding method and an apparatus that, when the intra template matching prediction (IntraTMP) technology is applied to the current block, adaptively determine search regions for template matching and the search order with the search regions. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating search regions in intra template matching prediction (IntraTMP).

FIG. 7 is a diagram illustrating changes in search regions in IntraTMP.

FIG. 8 is a diagram illustrating the search regions in IntraTMP, according to at least one embodiment of the present disclosure.

FIG. 9 is a block diagram showing in detail a part of the video decoding apparatus according to at least one embodiment of the present disclosure.

FIG. 10 is a diagram illustrating templates according to some embodiments of the present disclosure.

FIG. 11 is a diagram illustrating neighboring blocks of the current block according to at least one embodiment of the present disclosure.

FIG. 12 is a diagram illustrating search regions in IntraTMP, according to another embodiment of the present disclosure.

FIG. 13 is a diagram illustrating changes in search regions, according to at least one embodiment of the present disclosure.

FIG. 14 is a diagram illustrating changes in search regions, according to another embodiment of the present disclosure.

FIG. 15 is a flowchart of a method of encoding a current block by a video encoding apparatus, according to at least one embodiment of the present disclosure.

FIG. 16 is a flowchart of a method of reconstructing a current block by a video decoding apparatus, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

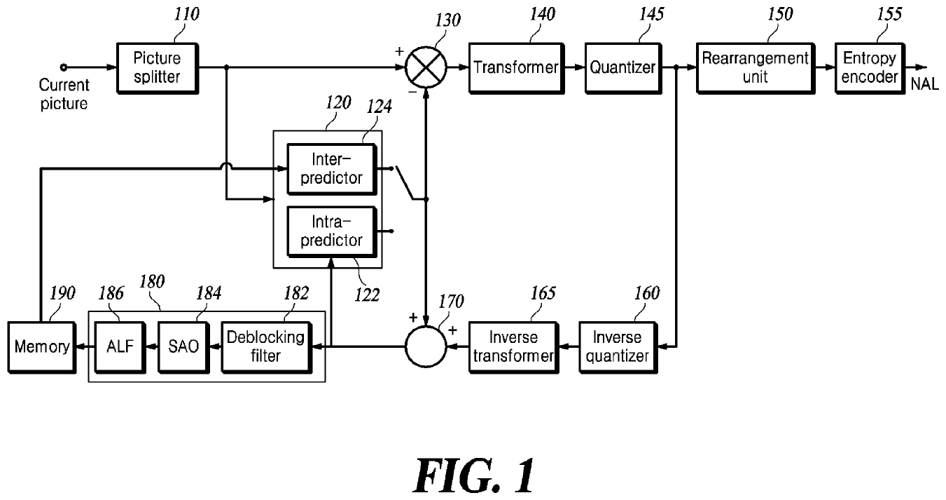

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUS included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

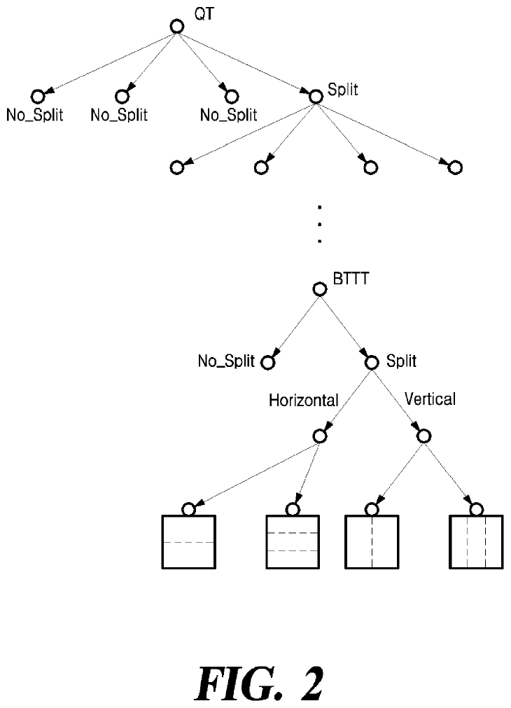

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

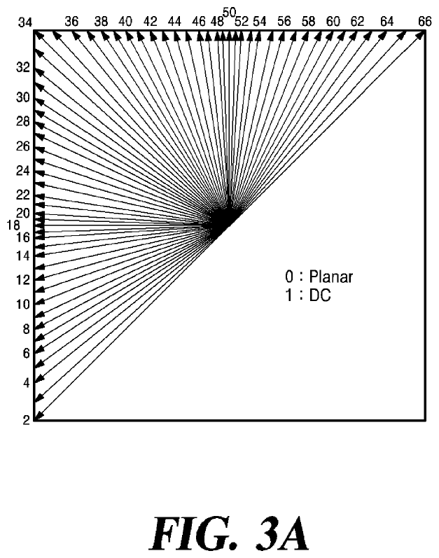

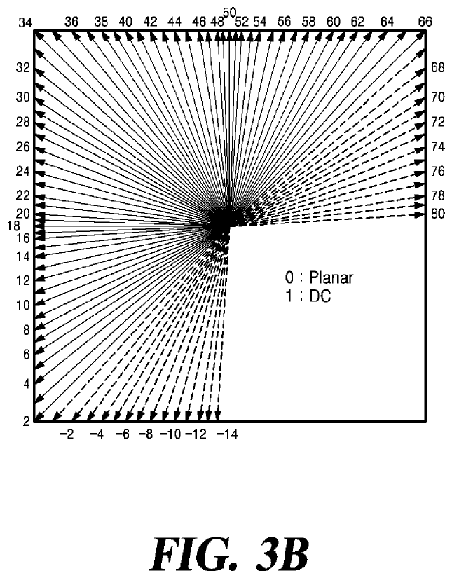

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (intra prediction modes #67 to #80, #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

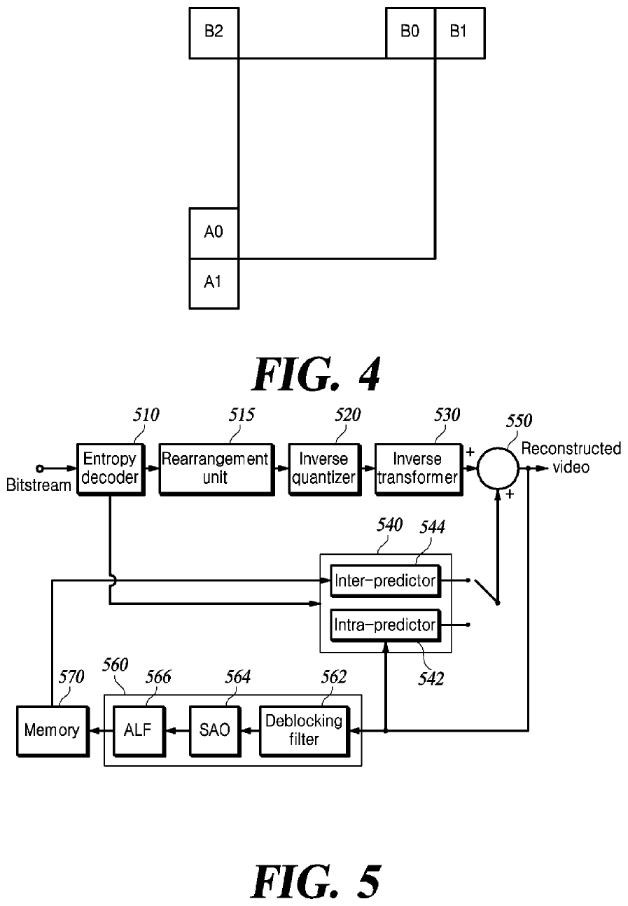

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform function or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510, and predicts the current block by using the motion vector and the reference picture.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that, when the intra template matching prediction (IntraTMP) technique is applied to the current block, adaptively determine search regions for template matching and the search order with the search regions.

The following embodiments may be performed by the intra predictor 122 in the video encoding device. The following embodiments may also be performed by the intra predictor 542 in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

### I. Intra Template Matching Prediction (IntraTMP)

In enhanced compression model (ECM), which is a next-generation technology, the IntraTMP technology sets an L-shaped, left, and/or top template neighboring the current block, searches for the template most similar to the current template in the reconstructed region of the current frame, and then takes a block adjacent to the searched template and with the same size as the current block for use as the prediction block of the current block. The IntraTMP technique searches for similar templates based on a loss function, using sum of absolute differences (SAD) as the loss function.

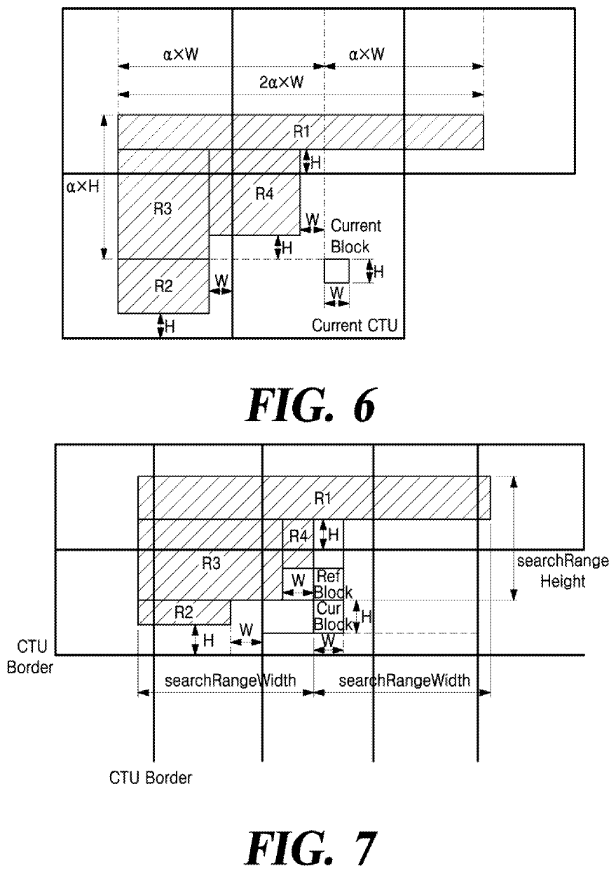

As FIG. 6 illustrates, four search regions may be represented for template matching. In ECM, a shown in FIG. 6 is set to 5. With respect to the search regions shown in FIG. 6, the IntraTMP technique uses the search order R4→R1→R3→R2, and uses a reverse z-scan order, searching from the bottom right to the top left in each search region. The IntraTMP technique may search the template in 2-pixel units in each search region after 2× upsampling, instead of performing a pixel-by-pixel search. The IntraTMP technique performs precise template matching in the region holding the template with the minimum cost to determine the final template, and then determines the prediction block adjacent to the final template.

FIG. 7 is a diagram illustrating changes in search regions in IntraTMP.

In another example of FIG. 7, R3 and R4 search regions for template matching may be changed. Based on the width/height (W/H) of the current block, the boundaries of the search region are determined by α×W and α×H in the example of FIG. 6, but in the example of FIG. 7, α×W and a H are changed to SearchRangeWidth and SearchRangeHeight, respectively. SearchRangeWidth is defined as max(α×W, minSearchRange), and SearchRangeHeight is defined as max(α×H, minSearchRange). As in the example in FIG. 6, α is set to 5 in the example in FIG. 7. Additionally, minSearchRange is set to 64.

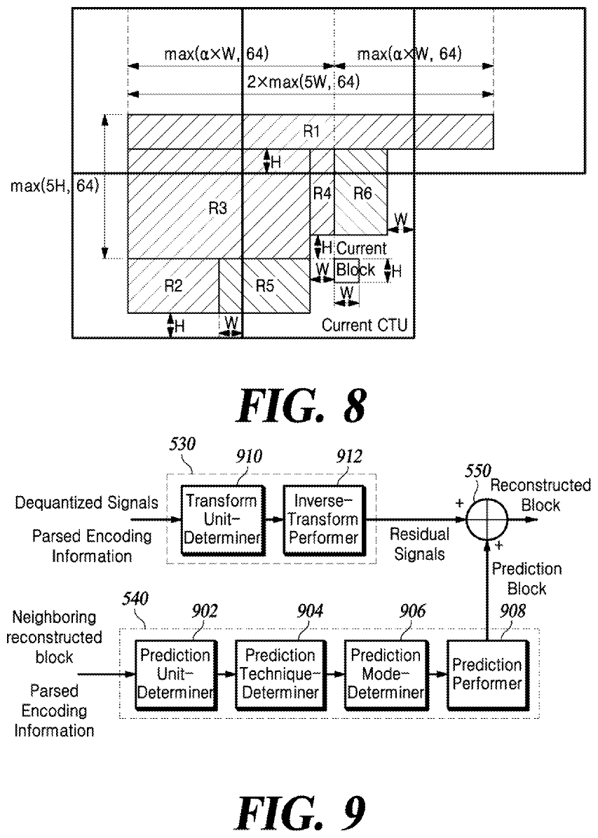

FIG. 8 is a diagram illustrating the search regions in IntraTMP, according to at least one embodiment of the present disclosure.

As shown in the embodiment in FIG. 8, the search regions for template matching may be changed. In addition to the R1, R2, R3, and R4 regions, R5 and R6 regions are added as search regions, as shown in the example in FIG. 8. Namely, search for template matching may be performed in the newly defined R5 and R6 regions. The search order according to the example in FIG. 8 is set as R4→R5→R6→R1→R3→R2.

The following embodiments are described with a focus on the video decoding apparatus, but they may be implemented in the same or similar manner in the video encoding apparatus.

### II. Embodiments According to the Present Disclosure

The video decoding apparatus according to some embodiments may determine prediction and transform units, and in response to a current block corresponding to the determined unit, may perform a prediction and an inverse transform by using a determined prediction technique and prediction mode, to finally generate a reconstructed block of the current block. The operations illustrated in FIG. 9 may be performed by the inverse transformer 530, the predictor 540, and the adder 550 of the video decoding apparatus. On the other hand, the same operations as illustrated in FIG. 9 may be performed by the inverse transformer 165, the picture splitter 110, the predictor 120, and the adder 170 of the video encoding apparatus. In this case, the video decoding apparatus uses encoding information parsed from the bitstream, but the video encoding apparatus may use encoding information set from a high level in terms of minimizing bit rate distortion. Hereinafter, for convenience, the embodiments are described centering on the video decoding apparatus.

As illustrated in FIG. 5, the predictor 540 includes the intra predictor 542 and the inter predictor 544, depending on the prediction technique, but as illustrated in FIG. 9, the predictor 540 may include all or part of a prediction unit-determiner 902, a prediction technique-determiner 904, a prediction mode-determiner 906, and a prediction performer 908.

If the color format of the input video is a YUV format (YUV420, YUV411, YUV422, YUV444, or the like), the video decoding apparatus may perform prediction and reconstruction of the luma component, and then may perform prediction and reconstruction of the chroma component. In this way, the luma component and the chroma component may be sequentially reconstructed by the components illustrated in FIG. 9. On the other hand, if the color format of the input video is RGB, the video encoding apparatus may perform a color format conversion from RGB to YUV, and then may encode the converted video. Here, in the YUV format, the color format represents a correspondence between pixels in the luma component and pixels in the chroma component.

The prediction unit-determiner 902 determines a prediction unit (PU). The prediction technique-determiner 904, in response to the prediction unit, determines a prediction technique, e.g., intra prediction, inter prediction, or intra block copy (IBC) mode, palette mode, or the like. The prediction mode-determiner 906 determines a detailed prediction mode for the prediction technique. The prediction performer 908 generates a prediction block of the current block according to the determined prediction mode.

The inverse transformer 530 includes a transform unit-determiner 910 and an inverse transform performer 912. The transform unit-determiner 910 determines a transform unit (TU) in response to the dequantized signals of the current block, and the inverse transform performer 912 inversely transforms the transform unit represented by the dequantized signals to generate residual signals.

The adder 550 sums the prediction block and the residual signals to generate a reconstructed block. The reconstructed block is stored in memory and may be used for predicting other blocks in the future.

The prediction unit determined by the prediction unit-determiner 902 may become the current block or one subblock of the subblocks split from the current block. In this case, the prediction unit of the chroma component may correspond in size to the prediction unit of the luma component, depending on the color format. Alternatively, the prediction units of the luma component and the chroma component may be determined separately, and the prediction may be performed in response to the prediction unit of the chroma component.

The prediction technique-determiner 904 determines a prediction technique for the prediction units. As described above, the prediction technique may be one of inter prediction, intra prediction, IBC mode, and palette mode. In this case, the prediction technique for the chroma component may be determined to be the same as the prediction technique of the corresponding luma component without signaling and parsing any additional information.

In one example, if the prediction technique of the current block is not intra prediction, the video decoding apparatus parses the 1-bit flag information. If the parsed flag indicates a skip mode, the video decoding apparatus may determine the prediction mode of the current block to be an inter prediction merge mode or an IBC merge mode. In the skip mode, the video decoding apparatus may also use the predicted signals in place of reconstructed signals, while skipping an inverse transform, i.e., without parsing residual signals.

On the other hand, if the parsed flag does not indicate a skip mode in response to the current block, the prediction technique-determiner 904 may determine one of the prediction techniques, such as inter prediction, intra prediction, IBC mode, palette mode, or the like, by parsing a series of 1-bit flags to be the prediction technique of the current block.

For example, if skip mode is not applied to the current block and the inter prediction or IBC mode is determined to be the prediction technique, the video decoding apparatus parses a 1-bit flag. The video decoding apparatus may determine, based on the parsed flag, the prediction mode of the current block to be the regular merge mode or AMVP (advanced motion vector prediction) mode.

The prediction mode-determiner 906 determines a detailed prediction mode for the prediction technique.

As an example, when the prediction technique for the current block is intra prediction, the prediction mode-determiner 906 may determine the prediction mode for the current block to be a single directional prediction mode, a planar mode that is a horizontal planar, vertical planar, or regular planar, or a DC mode.

In another example, when the prediction technique for the current block is intra prediction, the prediction mode-determiner 906 may determine the prediction mode for the current block to be a matrix-based intra-prediction mode. The matrix is predefined by an agreement between the video encoding apparatus and the video decoding apparatus. For matrix-based prediction, the video encoding apparatus/video decoding apparatus may signal/parse an index indicating the matrix used for prediction, or may signal/parse the matrix itself.

As another example, when the prediction technique for the current block is intra prediction, the prediction mode-determiner 906 may determine the prediction mode for the current block to be the IntraTMP mode.

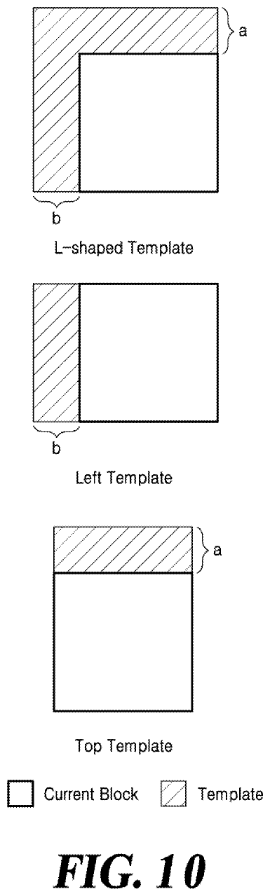

As shown in the example in FIG. 10, the IntraTMP mode uses positive integers ‘a’ and ‘b’ to define the L-shaped, left, and/or top region as a template in the neighboring reconstructed region of the current block. Thereafter, the IntraTMP mode performs template matching in the neighboring region of the current block to search for a similar template for generating predicted signals of the current block.

The prediction performer 908 generates the prediction block of the current block according to the determined prediction technique and prediction mode.

The following describes the prediction of the current block according to the IntraTMP mode.

The video decoding apparatus parses a flag that indicates whether the IntraTMP mode is to be applied (hereinafter referred to as the “IntraTMP flag”). By checking the IntraTMP flag, if the IntraTMP flag is false, the video decoding apparatus generates predicted signals of the current block according to a different intra-prediction mode other than the IntraTMP mode.

On the other hand, when the IntraTMP flag is true, i.e., when the prediction mode is determined to be IntraTMP, the video decoding apparatus generates the prediction block of the current block as follows. The video decoding apparatus determines search regions for template matching (TM) from the neighboring reconstructed region of the current block and determines the search order for the search regions. The video decoding apparatus performs region-by-region searches according to the determined search order to search for the template with the minimum cost. On the region where the template with the minimum cost is searched, the video decoding apparatus performs pixel-level searches to determine the optimal template. Subsequently, the video decoding apparatus determines the block adjacent to the determined optimal template and with the same size as the current block to be the prediction block of the current block.

At this time, to search for a template in each search region, the video decoding apparatus upsamples the template of the current block and each search region by N pixels, before performing the search. Here, N represents a positive integer. For each search region, the video decoding apparatus performs the search in the determined order from the bottom-right corner to the top-left corner of each search region. The determined order may be, for example, a reverse z-scan order, a reverse diagonal scan order, or a reverse raster scan order.

As an example, to determine the degree of template matching during the search, the video decoding apparatus calculates the cost by using one of metrics such as sum of absolute differences (SAD) or mean squared error (MSE), and determines the similarity from template matching based on the calculated cost. As an example, if a template with a cost smaller than a preset threshold is found during the search of each search region, the video decoding apparatus may terminate the search in that region early.

As an example, when the prediction mode of the current block having a size of W×H is IntraTMP, the video decoding apparatus may determine the R1 to R6 search regions based on the integer α, as illustrated FIG. 8. In the example of FIG. 8, α is set to 5 as described above.

As an example, the search regions may be established by referring to Coding Tree Units (CTUs) among the neighboring reconstructed regions of the current block. In the example shown in FIG. 8, the search regions are distributed over the current CTU, left CTU, top-left CTU, top CTU, and top-right CTU.

As an example, the video decoding apparatus determines the search order of the search regions as R4→R5→R6→R1→R3→R2. Additionally, the search order may be implicitly determined based on the size of the current block, information about neighboring reconstructed regions, and the like.

In another example, the video decoding apparatus determines the search order as top→left→top left relative to the current block. In the example of FIG. 8, R6 represents the top search region, R1, R3, and R4 regions represent the top-left search region, and R2 and R5 regions represent the left search region. With the search regions included in the top search region, top-left search region, or left search region, the search order may be determined based on the distance from the current block. For example, the search may be performed starting from the nearest region. Based on the above-mentioned determination of the search order, the video decoding apparatus may determine the search order as R6→R5→R2→R4→R3→R1. Hereinafter, the top, top-left, or left search regions are each referred to as the upper-level search region or upper search level, and the R1 to R6 search regions are each referred to as the lower-level search region or lower search region or simply search region.

As described above, the video decoding apparatus performs the search in each search region in a predetermined order from the bottom right to the top left. Alternatively, the video decoding apparatus may perform the search in each search region starting from pixels close to the current block.

Hereinafter, the term ‘adjacent’ refers to two objects being spatially contiguous, and the term ‘neighboring’ includes the meaning of ‘adjacent’ and refers to objects that are within a certain distance of each other.

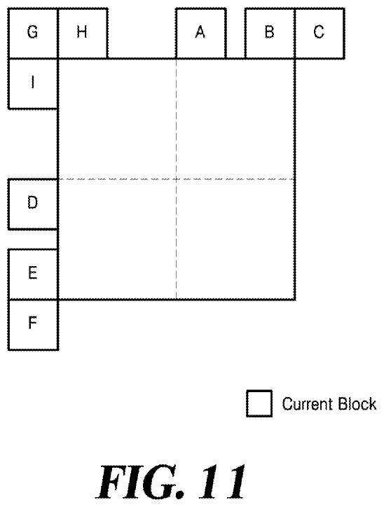

As an example, the video decoding apparatus may check the motion information of reconstructed regions adjacent to the current block, as shown in the example in FIG. 11, and then reorder the search order of search regions, resize search regions, and relocate search regions for template matching based on the checked motion information. Among the regions A to I shown in FIG. 11, the video decoding apparatus may use only some of the regions. When IBC (intra block copy) is applied to the adjacent block, the motion information is the BV (block vector). Additionally, when the IntraTMP mode is applied to the adjacent block, the motion information is the BV corresponding to the IntraTMP mode. Here, the BV corresponding to the IntraTMP mode indicates the displacement between the template of the adjacent block and the template of the prediction block of the adjacent block. In the example of FIG. 11, the adjacent region containing A, B, and C blocks is defined as the top region of the current block, the adjacent region containing D, E, and F blocks is defined as the left region of the current block, and the adjacent region containing G, H, and I blocks is defined as the top-left region of the current block.

Meanwhile, IBC copies the reference block within the common frame by using the block vector to generate the prediction block of the current block and thereby performs intra prediction of the current block. The video encoding apparatus performs block matching to derive the optimal block vector. Here, the block vector indicates the displacement from the current block to the reference block.

As an example, the video decoding apparatus may implicitly determine the search order, search region size, and search region location for template matching based on the motion information of the top region, left region, and top-left region of the current block. The video decoding apparatus may obtain the current block's top motion information by identifying one or more regions among the A, B, and C blocks in the example shown in FIG. 11. The video decoding apparatus may obtain the current block's left motion information by identifying one or more regions among the D, E, and F blocks in the example of FIG. 11. The video decoding apparatus may obtain the current block's top-left motion information by identifying one or more regions among the G, H, and I blocks in the example of FIG. 11.

As an example, the motion information of the current block's top region, left region, or top-left region may be the average or median value of the motion information items of the adjacent blocks included in that region.

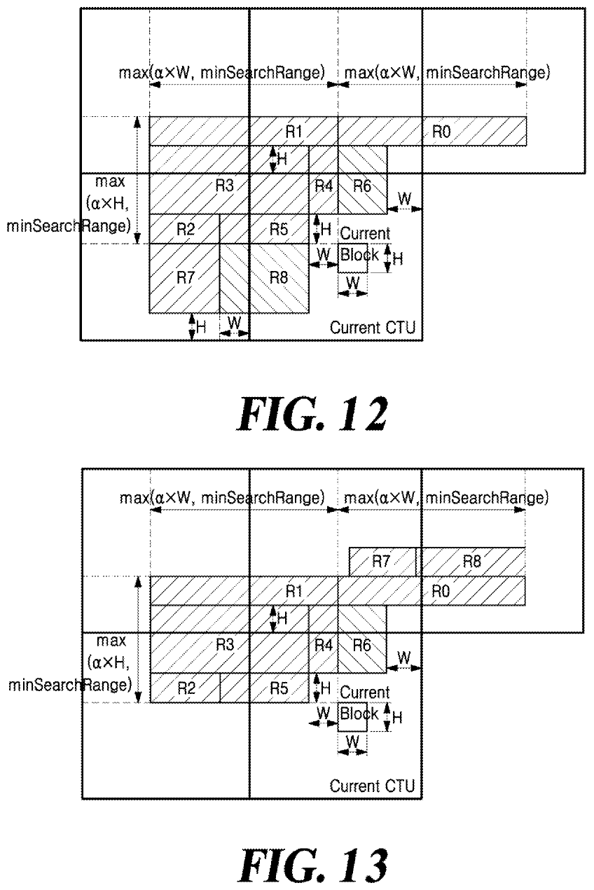

FIG. 12 is a diagram illustrating search regions in IntraTMP, according to another embodiment of the present disclosure.

In an example as illustrated in FIG. 12, when the prediction mode of the current block having a size of W×H is IntraTMP, the video decoding apparatus may determine R0 to R8 search regions based on an integer a. At this time, a preset value may be used for minSearchRange. Lower-level R0 and R6 search regions are included in the top search region, lower-level R1, R2, R3, R4, and R5 search regions are included in the top-left search region, and lower-level R7 and R8 search regions are included in the left search region.

As an example, the video decoding apparatus may determine the search regions as follows.

The video decoding apparatus may define R0 to R8 as illustrated in FIG. 12 to be the lower-level search regions for template matching of the current block and then may adjust the search regions based on the motion information of the reconstructed region adjacent to the current block.

FIG. 13 is a diagram illustrating changes in search regions, according to at least one embodiment of the present disclosure.

As an example, by identifying the motion information of the left region, top-left region, and top region neighboring the current block, if no motion information is present on the left, the video decoding apparatus may change the R7 and R8 regions, i.e., the left search region, as illustrated in FIG. 13. In the example of FIG. 13, the video decoding apparatus relocates the left search regions R7 and R8 to the top region of the current block. The video decoding apparatus may change the search regions by checking only the motion information of the left region and top region neighboring the current block.

At this time, after defining the total area of the search regions as S, the video decoding apparatus may change the R7 and R8 regions while maintaining the total area of the search regions.

When the R7 and R8 regions are changed as illustrated in FIG. 13 and the changed R7 and R8 regions make a deviating region that is outside of the top boundary of a CTU above the current CTU, the video decoding apparatus may not perform a search in the deviating region.

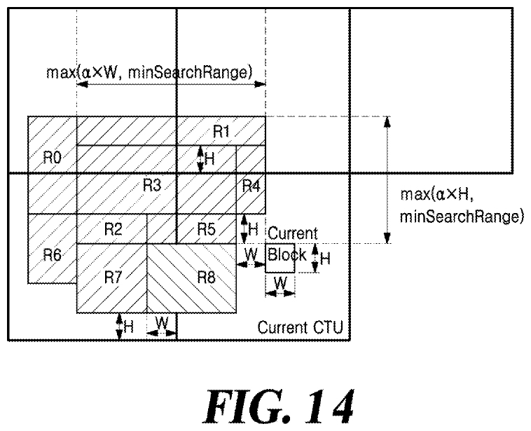

FIG. 14 is a diagram illustrating changes in search regions, according to another embodiment of the present disclosure.

In another example as illustrated in FIG. 14, when the video decoding apparatus identifies the motion information of the left region, top-left region, and top region neighboring the current block and finds no top motion information, it may change the R0 and R6 regions, i.e., the top search regions. In the example of FIG. 14, the video decoding apparatus relocates the top search regions R0 and R6 to the left of the current block. The video decoding apparatus may change the search regions by checking only the motion information of the left region and top region neighboring the current block.

At this point, after defining the total area of the search regions as S, the video decoding apparatus may change the R0 and R6 regions while maintaining the total area of the search regions.

When the R0 and R6 regions are changed as illustrated in FIG. 14 and the changed R0 and R6 regions make a deviating region that is outside of the left boundary of a CTU on the left side of the current CTU, the video decoding apparatus may not perform a search in the deviating region.

As an example, the video decoding apparatus may determine the search order as follows.

The video decoding apparatus may define R0 to R8 as shown in the example of FIG. 12 to be the lower-level search regions for template matching of the current block, and then adjust the search order based on the motion information of the reconstructed region adjacent to the current block.

As an example, the video decoding apparatus may search the upper-level search regions according to a preset search order. For example, it may search the search regions in the order of top→left→top left. Namely, the video decoding apparatus may search the R0 and R6 regions, then search the R7 and R8 regions, and finally search the R1, R2, R3, R4, and R5 regions. As described above, with respect to the lower-level search regions in the top search region, the lower-level search regions in the left search region, or the lower-level search regions in the top-left search region, the search order may be determined based on the distance from the current block. For example, the search may be performed starting from the nearest region. Therefore, the order R6→R0 is defined as the default search order in the top search region, the order R8→R7 is defined as the default search order in the left search region, and the order R4→R5→R3→R1→R2 is defined as the default search order in the top-left search region. Furthermore, the above-described search order may be changed.

When one or more adjacent blocks above the current block are predicted according to IBC or IntraTMP, the video decoding apparatus uses the relevant motion information to determine the search order of the lower-level search regions in the top search region. For example, when the current block's top motion information indicates the interior of the R0 region, the video decoding apparatus reorders the search for the top search region to R0→R6. On the other hand, when the current block's top motion information indicates the interior of the R6 region, the video decoding apparatus maintains the default search order of R6→R0. At this time, the video decoding apparatus may use only the regions within the R6 region, which have been reconstructed and are available for use in the search. Even if the R7 and R8 regions are relocated to the top of the current block based on the motion information, the above-described change in the search order may be applied.

As another example, when one or more adjacent blocks in the top-left corner of the current block are predicted based on IBC or IntraTMP, the video decoding apparatus uses the relevant motion information to reorder the search for the lower-level search regions in the top-left search region. As mentioned earlier, the top-left search region uses the default search order of R4→R5→R3→R1→R2. The video decoding apparatus may reorder the default search order based on motion information. In relation to the above-described default search order, the video decoding apparatus may determine the search order of the top-left region by changing the region indicated by the current block's top-left motion information to the highest priority search order. For example, when the current block's top-left motion information indicates the R3 region, the video decoding apparatus may search the top-left search region in the order R3→R4→R5→R1→R2.

As yet another example, when one or more adjacent blocks to the left of the current block are predicted according to IBC or IntraTMP, the video decoding apparatus uses the relevant motion information to determine the search order of the lower-level search regions in the left search region. For example, when the current block's left motion information indicates the interior of the R7 region, the video decoding apparatus reorders the search for the left search region to R7→R8. On the other hand, when the current block's left motion information indicates the interior of the R8 region, the video decoding apparatus maintains the default search order of R8→R7. At this time, the video decoding apparatus may use only the regions within the R8 region, which have been reconstructed and are available for use in the search. Even if the R0 and R6 regions are relocated to the left of the current block based on the motion information, the above-described change in the search order may be applied.

The following describes matters related to the inverse transform.

The entropy decoder 510 is responsive to the secondary transform being applied for decoding quantized secondary transform coefficients from the bitstream. On the other hand, when no secondary transform is applied, the entropy decoder 510 decodes the quantized primary transform coefficients. In addition, the entropy decoder 510 decodes the quantization method and quantization parameters of the decoded transform coefficients.

The inverse quantizer 520 dequantizes the transform coefficients quantized based on the decoded quantization method and quantization parameters and thereby generates dequantized transform coefficients.

The transform unit-determiner 910 determines the transform unit (TU) for the current block as described above. The unit for inverse transform may be a single TU. Alternatively, the unit for inverse transform may be each of a plurality of subblocks generated by dividing a single TU.

The inverse transform performer 912 may be responsive to a secondary transform being applied for determining a non-separable secondary inverse transform kernel. Furthermore, the inverse transform performer 912 may determine a separable primary inverse transform kernel or a non-separable primary inverse transform kernel. As described above, the inverse transform performer 912 applies the determined inverse transform kernel to the dequantized transform coefficients to generate residual signals of the current block. Subsequently, the video decoding apparatus sums the current block's prediction block and residual signals to generate a reconstructed block of the current block.

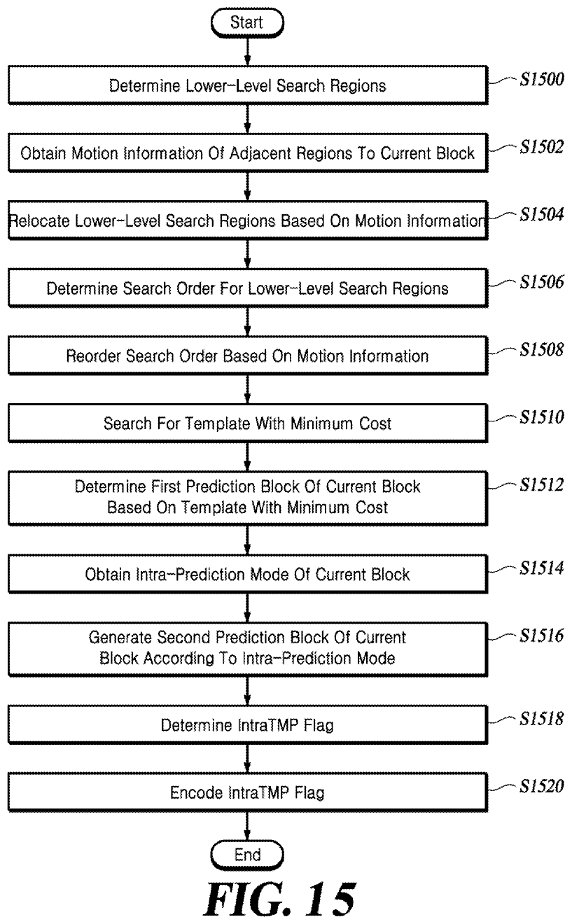

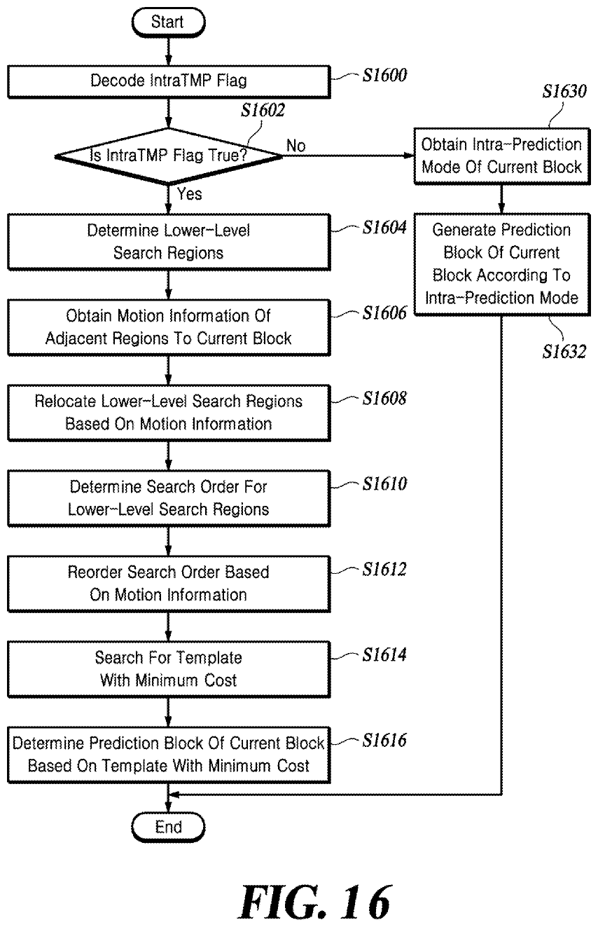

By using the illustrations in FIGS. 15 and 16, the following describes the methods of encoding and reconstructing the current block according to the IntraTMP mode.

FIG. 15 is a flowchart of a method of encoding the current block by the video encoding apparatus, according to at least one embodiment of the present disclosure.

The video encoding apparatus determines lower-level search regions for template matching from the neighboring reconstructed regions of the current block (S1500).

Here, each of the lower-level search regions is included in one of the upper-level search regions. The upper-level search regions are composed of a top search region, a left search region, and a top-left search region, and each of the upper-level search regions includes at least two or more lower-level search regions.

The video encoding apparatus obtains motion information of adjacent regions to the current block (S1502).

The adjacent regions to the current block include the top region, left region, and top-left region of the current block. Each of the adjacent regions is a reconstructed region and includes at least one adjacent block.

When the IBC mode is applied to the adjacent block to the current block, the motion information is a block vector, and when the IntraTMP mode is applied to the adjacent block, the motion information is the displacement between the template of the adjacent block and the template of the prediction block of the adjacent block.

The video encoding apparatus relocates the lower-level search regions based on the motion information (S1504).

When no motion information is present for the left region of the current block, the video encoding apparatus relocates the lower-level search regions included in the left search region to the top of the top search region. Alternatively, when no motion information is present for the top region of the current block, the video encoding apparatus relocates the lower-level search regions included in the top search region to the left of the left search region.

The video encoding apparatus determines the search order of the lower-level search regions (S1506).

The video encoding apparatus sets a preset search order for the upper-level search regions. For example, the preset search order may be top→left→top-left search regions. The video encoding apparatus may determine the search order with respect to the lower-level search regions included in each of the upper-level search regions in the order from the lower-level search region closest to the current block to the lower-level search region farthest from the current block.

The video encoding apparatus reorders the search order based on the motion information (S1508).

For example, when one or more adjacent blocks in the top region of the current block are predicted according to the IBC mode or IntraTMP mode, the video encoding apparatus reorders the search order to first search the lower-level search region in the top search region, indicated by the motion information of the adjacent block.

The video encoding apparatus performs region-by-region searches according to the search order and searches for the template with the minimum cost based on the cost associated with template matching (S1510). Here, the cost associated with template matching may be calculated based on the differences between the template of the current block and the templates within respective lower-level search regions.

The video encoding apparatus upsamples, for each preset number of pixels, the template of the current block and the respective lower-level search regions, and then searches for the template with the minimum cost in the preset order from the bottom-right corner to the top-left corner of each of the lower-level search regions.

The video encoding apparatus determines the first prediction block of the current block based on the template with the minimum cost (S1512).

The video encoding apparatus performs a pixel-level search in the lower-level search region containing the template with the minimum cost to determine the optimal template. The video encoding apparatus may determine the block adjacent to the optimal template as the first prediction block.

The video encoding apparatus obtains the intra-prediction mode of the current block (S1514). The video encoding apparatus may obtain the intra-prediction mode of the current block from the high level, while it excludes the IntraTMP mode. Alternatively, the video encoding apparatus may determine the intra-prediction mode of the current block from the perspective of rate-distortion optimization.

The video encoding apparatus generates a second prediction block of the current block according to the intra-prediction mode (S1516).

The video encoding apparatus determines the IntraTMP flag based on the first prediction block and the second prediction block (S1518). Here, the IntraTMP flag indicates whether the IntraTMP mode is to be applied based on template matching. From the perspective of rate-distortion optimization, the video encoding apparatus may determine the IntraTMP flag. For example, if the first prediction block is optimal, the IntraTMP flag is determined to be true. On the other hand, if the second prediction block is optimal, the IntraTMP flag is determined to be false.

The video encoding apparatus encodes the IntraTMP flag (S1520).

Subsequently, the video encoding apparatus checks the IntraTMP flag and generates residual signals according to the value of the IntraTMP flag by subtracting the first prediction block or the second prediction block from the current block. The video encoding apparatus transforms/quantizes the residual signals to generate quantized transform coefficients and encodes the quantized transform coefficients.

FIG. 16 is a flowchart of a method of reconstructing a current block by the video decoding apparatus, according to at least one embodiment of the present disclosure.

The video decoding apparatus decodes the IntraTMP flag from the bitstream (S1600). Here, the IntraTMP flag indicates whether intra prediction based on template matching is to be applied.

The video decoding apparatus checks the IntraTMP flag (S1602).

If the IntraTMP flag is true (Yes in S1602), the video decoding apparatus performs the following steps.

The video decoding apparatus determines lower-level search regions for template matching in the reconstructed region neighboring the current block (S1604).

Here, each of the lower-level search regions is included in one of the upper-level search regions. The upper-level search regions are composed of the top search region, the left search region, and the top-left search region, and each of the upper-level search regions includes at least two or more lower-level search regions.

The video decoding apparatus obtains motion information of adjacent regions to the current block (S1606).

The adjacent regions to the current block include the top region, the left region, and the top-left region. Each of the adjacent regions is a reconstructed region and includes at least one adjacent block.

When the IBC mode is applied to the adjacent block to the current block, the motion information is a block vector, and when the IntraTMP mode is applied to the adjacent block, the motion information is the displacement between the template of the adjacent block and the template of the prediction block of the adjacent block.

The video decoding apparatus relocates the lower-level search regions based on the motion information (S1608).

If no motion information is present for the left region of the current block, the video decoding apparatus relocates the lower-level search regions included in the left search region to the top of the top search region. Alternatively, if no motion information is present for the top region of the current block, the video decoding apparatus relocates the lower-level search regions included in the top search region to the left of the left search region.

The video decoding apparatus determines the search order of the lower-level search regions (S1610).

The video decoding apparatus provides a preset search order for the upper-level search regions. For example, the preset search order may be top→left→top-left search regions in that order. The video decoding apparatus may determine the search order with the lower-level search regions included in each of the upper-level search regions in the order from the lower-level search region closest to the current block to the lower-level search region farthest from the current block.

The video decoding apparatus reorders the search order based on the motion information (S1612).

For example, when one or more adjacent blocks in the top region of the current block are predicted according to the IBC mode or IntraTMP mode, the video decoding apparatus reorders the search order to first search in the top search region the lower-level search region indicated by the motion information of the adjacent block.

The video decoding apparatus performs region-by-region searches according to the search order and searches for the template with the minimum cost based on the cost associated with template matching (S1614). Here, the cost associated with template matching may be calculated based on the difference between the template of the current block and the templates within the respective lower-level search regions.

The video decoding apparatus upsamples, for each preset number of pixels, the template of the current block and the respective lower-level search regions, and then searches for the template with the minimum cost in the preset order from the bottom-right corner to the top-left corner of each of the lower-level search regions.

The video decoding apparatus determines the prediction block of the current block based on the template with the minimum cost (S1616).

The video decoding apparatus performs a pixel-by-pixel search in the lower-level search region containing the template with the minimum cost to determine the optimal template. The video decoding apparatus may determine the block adjacent to the optimal template as the prediction block.

If the IntraTMP flag is false (No in S1602), the video decoding apparatus performs the following steps.

The video decoding apparatus obtains the intra-prediction mode of the current block (S1630). The intra-prediction mode of the current block is a prediction mode other than IntraTMP mode. The video decoding apparatus may decode the intra-prediction mode of the current block from the bitstream or derive it implicitly.

The video decoding apparatus generates a prediction block of the current block according to the intra-prediction mode (S1632).

The video decoding apparatus decodes the quantized transform coefficients from the bitstream, inversely quantizes/inversely transforms the quantized transform coefficients to reconstruct the residual signals, and sums the prediction block and the residual signals to generate the reconstructed block of the current block.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “. . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### Reference Numerals

122: intra predictor
542: intra predictor
902: prediction unit-determiner
904: prediction technique-determiner
906: prediction mode-determiner
908: prediction performer

### CROSS-REFERENCE TO RELATED APPLICATIONS

This application claims priority to and the benefit of Korean Patent Application No. 10-2023-0060327 filed on May 10, 2023, and Korean Patent Application No. 10-2024-0030641, filed on Mar. 4, 2024, the entire contents of each of which are incorporated herein by reference.

1. A method of reconstructing a current block by a video decoding apparatus, the method comprising:
determining lower-level search regions in a neighboring reconstructed region of the current block for use in template matching, each of the lower-level search regions being included in one of upper-level search regions that comprise a top search region, a left search region, and a top-left search region, and each of the upper-level search regions including at least two or more lower-level search regions;
obtaining motion information of adjacent regions to the current block;
relocating the lower-level search regions based on the motion information;
determining a search order with respect to the lower-level search regions based on distances from the current block;
searching for a template with a minimum cost based on a cost of the template matching by performing a region-by-region search in the search order, the cost being dependent on a difference between a template of the current block and a template in each of the lower-level search regions; and
determining a prediction block of the current block based on the template with the minimum cost.

2. The method of claim 1, further comprising:
decoding from a bitstream an intra template matching prediction flag (IntraTMP flag) that indicates whether an IntraTMP mode is to be applied based on the template matching; and
checking the IntraTMP flag,
wherein the method proceeds, when the IntraTMP flag is true, with determining the lower-level search regions.

3. The method of claim 1, wherein searching for the template with the minimum cost comprises:
upsampling, for each preset number of pixels, the template of the current block and each of the lower-level search regions, and then searching for the template with the minimum cost in a preset order from a bottom-right corner to a top-left corner of each of the lower-level search regions.

4. The method of claim 1, further comprising:
determining an optimal template by performing a pixel-by-pixel search in a lower-level search region including the template with the minimum cost,
wherein determining the prediction block of the current block comprises:
determining a block adjacent to the optimal template as the prediction block.

5. The method of claim 1, wherein determining the search order comprises:
setting a preset search order with respect to the upper-level search regions, and determining the search order with respect to the lower-level search regions included in each of the upper-level search regions, starting from lower-level search regions closer to the current block toward an end with lower-level search regions farther from the current block.

6. The method of claim 1, wherein the adjacent regions to the current block include:
a top region, a left region, and a top-left region of the current block, and
wherein each of the adjacent regions to the current block is a reconstructed region and includes at least one adjacent block.

7. The method of claim 6, wherein the motion information is a block vector when an intra block copy mode (IBC mode) is applied to the adjacent block, and the motion information is a displacement between a template of the adjacent block and a template of a prediction block of the adjacent block when an intra template matching prediction mode (IntraTMP mode) is applied to the adjacent block.

8. The method of claim 6, wherein relocating the lower-level search regions comprises, when the left region of the current block lacks motion information:
relocating lower-level search regions included in the left search region to an upper side of the top search region; and
wherein searching for the template with the minimum cost comprises:
when the lower-level search regions after relocating generate a deviating region that is outside of a top boundary of a top coding tree unit (CTU) of a current CTU, skipping a search for the deviating region.

9. The method of claim 6, wherein relocating the lower-level search regions comprises, when the top region of the current block lacks motion information:
relocating lower-level search regions included in the top search region to a left side of the left search region; and
wherein searching for the template with the minimum cost comprises:
when the lower-level search regions after relocating generate a deviating region that is outside of a left boundary of a left coding tree unit (CTU) of a current CTU, skipping a search for the deviating region.

10. The method of claim 6, further comprising, when one or more adjacent blocks in the top region of the current block are predicted in an intra block copy mode (IBC mode) or an intra template matching prediction mode (IntraTMP mode):
reordering the search order to first search a lower-level search region indicated by motion information of the adjacent block in the top search region.

11. The method of claim 6, further comprising, when one or more adjacent blocks in the top-left region of the current block are predicted in an intra block copy mode (IBC mode) or an intra template matching prediction mode (IntraTMP mode):
reordering the search order to first search a lower-level search region indicated by motion information of the adjacent block in the top-left search region.

12. The method of claim 6, further comprising, when one or more adjacent blocks in the left region of the current block are predicted in an intra block copy mode (IBC mode) or an intra template matching prediction mode (IntraTMP mode):
reordering the search order to first search a lower-level search region indicated by motion information of the adjacent block in the left search region.

13. A method of encoding a current block by a video encoding apparatus, the method comprising:
determining lower-level search regions in a neighboring reconstructed region of the current block for use in template matching, each of the lower-level search regions being included in one of upper-level search regions that comprise a top search region, a left search region, and a top-left search region, and each of the upper-level search regions including at least two or more lower-level search regions;
obtaining motion information of adjacent regions to the current block;
relocating the lower-level search regions based on the motion information;
determining a search order with respect to the lower-level search regions based on distances from the current block;
searching for a template with a minimum cost based on a cost of the template matching by performing a region-by-region search in the search order, the cost being dependent on a difference between a template of the current block and a template in each of the lower-level search regions; and
determining a first prediction block of the current block based on the template with the minimum cost.

14. The method of claim 13, further comprising:
obtaining an intra-prediction mode of the current block; and
generating a second prediction block of the current block according to the intra-prediction mode.

15. The method of claim 14, further comprising:
determining, based on the first prediction block and the second prediction block, an intra template matching prediction flag (IntraTMP flag) that indicates whether an IntraTMP mode is to be applied based on the template matching; and
encoding the IntraTMP flag.

16. The method of claim 13, further comprising:
determining an optimal template by performing a pixel-by-pixel search in a lower-level search region including the template with the minimum cost,
wherein determining the first prediction block comprises:
determining a block adjacent to the optimal template as the first prediction block.

17. A computer-readable recording medium storing a bitstream generated by a video encoding method, wherein the video encoding method comprises:
determining lower-level search regions in a neighboring reconstructed region of a current block for use in template matching, each of the lower-level search regions being included in one of upper-level search regions that comprise a top search region, a left search region, and a top-left search region, and each of the upper-level search regions including at least two or more lower-level search regions;
obtaining motion information of adjacent regions to the current block;
relocating the lower-level search regions based on the motion information;
determining a search order with respect to the lower-level search regions based on distances from the current block;
searching for a template with a minimum cost based on a cost of the template matching by performing a region-by-region search in the search order, the cost being dependent on a difference between a template of the current block and a template in each of the lower-level search regions; and
determining a prediction block of the current block based on the template with the minimum cost.
